(19) United States
(12) Patent Application Publication
(10) Pub. No.: US 2013/0290103 A1
(43) Pub. Date: Oct. 31, 2013

(54) Affinity Relationship Based Ecommerce

(71) Applicants: Jeremy J. Paradise, (US); Doug A. Brenhouse, (US); Fabien J. R. Rousselot, (US); Andrew Kwasik, (US); Alastair Bridgewater, (US); Orlyn Reese, (US)

(72) Inventors: Jeremy J. Paradise, (US); Doug A. Brenhouse, (US); Fabien J. R. Rousselot, (US); Andrew Kwasik, (US); Alastair Bridgewater, (US); Orlyn Reese, (US)

(21) Appl. No.: 13/460,581

(22) Filed: Apr. 30, 2012

(51) Int. Cl. G06Q 30/02; G06Q 30/06

(52) U.S. Cl. 705/14.58; 705/14.49; 705/27.1

(57) ABSTRACT

Data characterizing an offer for sale of a good or service by a seller is received. The data specifies constraints of the offer. The constraints identify a plurality of groups of potential buyers to which the offer is to be conveyed and characterizes conditions specifying how the offer is to be conveyed to each group. At least one of the groups is determined based on an affinity relationship of the potential buyers in that group to the seller. The terms of the offer may vary between at least two of the plurality of groups based on the relationship. A plurality of formatted offers can be generated. Each formatted offer corresponds to a respective group and to an online marketplace. At least one of the formatted offers can be posted to a respective group according to the conditions. Related apparatus, systems, techniques and articles are also described.

### TECHNICAL FIELD

The subject matter described herein relates to improving online transactions, both for the seller and the buyer. Specifically, techniques are provided to: enable posting products for sale quickly and across multiple online marketplaces; leverage relationships to enable preferential offers for sale among groups of potential buyers; automatically tier offer postings to different online marketplaces and enable communication between sellers and buyers.

### BACKGROUND

An online marketplace is a type of ecommerce site where product and inventory information is provided by multiple third parties and transactions can be processed by the marketplace operator. Example online marketplaces include Amazon.com®, Ebay®, Craigslist, and Google Shopping®. Merchants wishing to sell products can use online marketplaces as channels for increased sales. Additionally, an online marketplace can receive a commission for goods sold through their marketplace.

Typically, a merchant (i.e. a seller) will post an offer to sell a product to an online marketplace. The offer for sale will specify a description, price, and can specify additional details (e.g. title, category, condition, duration of offer, if the price is negotiable, etc.). The offer for sale can be viewable by buyers. A buyer, browsing or searching the online marketplace, can buy or make an offer to buy the product. The seller and buyer can then complete the transaction by exchanging product for payment. The online marketplace can serve as a trusted intermediary in the transaction by providing for and enabling the exchange of product for payment. Alternatively, the transaction can be completed between the seller and buyer independent from the online marketplace e.g. in person or via a postal service.

A seller, wishing to increase the number of potential buyers their offers reach can post their offers to multiple online marketplaces. A number of challenges face sellers attempting to sell their products across multiple marketplaces. The posting and managing of items on multiple marketplaces is expensive, time intensive and difficult to manage. Sellers with limited resources, such as small companies and individuals, are unable to offer their products for sale across multiple channels.

Further, there is no easy way to sell goods both locally and non-locally. Typically, an online marketplace either operates with a local transaction model or a non-local transaction model. In a local transaction model (e.g. Craigslist), the seller and buyer must meet in person to finalize the transaction. In a non-local transaction model (e.g. Ebay), the seller and buyer complete the transaction remotely, for example, via the postal system. In both models, communication between seller and buyer is limited.

Further, the seller cannot distinguish between potential buyers. A seller can wish to be preferential to buyers if, for example, a friend or a member of a club the seller belongs to wished to buy the product. The friend can be more willing to buy a product once they know the seller and the seller's associations.

### SUMMARY

In one aspect, data characterizing an offer for sale of a good or service by a seller is received. The data specifies constraints of the offer. The constraints identify a plurality of groups of potential buyers to which the offer is to be conveyed and characterizes conditions specifying how the offer is to be conveyed to each group. At least one of the groups is determined based on an affinity relationship of the potential buyers in that group to the seller. The terms of the offer may vary between at least two of the plurality of groups based on the relationship. Using the received data, a plurality of formatted offers can be generated. Each formatted offer corresponds to a respective group and to an online marketplace. The formatted offers characterize the varying terms of the offer. At least two of the formatted offers have different terms. At least one of the formatted offers can be posted to a respective group according to the conditions which specify how the offer is to be conveyed to such group.

In another aspect, data characterizing an offer from a buyer to a seller to buy a product is received. The product is a good or service. The seller is an entity that posted the offer for sale of the product to an online marketplace. The buyer is an entity having viewed the offer for sale. Using the received data, a message is generated. The message withholds an identity of the buyer thereby making the buyer anonymous. The message characterizes the offer to buy and at least three structured seller replies. The first structured seller reply is a counter-offer, the second structured seller reply is an accepting of the offer to buy, and the third structured seller reply is a rejection of the offer to buy. The message is transmitted to the seller to prompt the seller to select one of the structured seller replies, thereby advancing a transaction between the seller and the buyer.

In another aspect, data characterizing a template offer, a plurality of online marketplaces and a location associated with the template offer is received. The location is based on a location of a mobile device. The template offer being the sale of a good or service and including a price associated with each of the plurality of online marketplaces. The price associated with at least two of the online marketplaces can differ. The received data is transformed into a plurality of formatted offers. Each formatted offer corresponds to a respective different online marketplace. At least one of the plurality of formatted offers includes the location associated with the template offer. The plurality of formatted offers is posted automatically to their respective online marketplaces thereby offering the product for sale at different prices. A buyer, through at least one of the respective different online marketplaces, can view and choose to accept one of the posted formatted offers.

One or more of the following features can be included. For example, the affinity relationship can comprise a connection to the seller via a social network. The social network can be selected from a group consisting of: Facebook, MySpace, LinkedIn, and Google+. The affinity relationship can include a connection to a common entity via a social network, the seller also having a connection to the common entity via a social network connection. The affinity relationship can include a membership in an association. The affinity relationship can include a geographical proximity to the seller. The affinity relationship can include a use of a specific online marketplace.

Posting to the respective group can include posting the formatted offers to online marketplaces, the online marketplaces can be selected from a group consisting of: Facebook, Myspace, LinkedIn, Google Shopping, Ebay, Eggdrop, Peddle, Amazon, and Craigslist. The varying terms of the offer can include a price. The varying terms of the offer can include a shipping fee. The conditions of offering the sale to a respective group can include a length of pendency of at least one of the posted formatted offers thereby providing an exclusivity period of offer pendency to at least one group.

Second data characterizing the selected structured reply can be received. The selected structured reply can be the counter-offer from the seller to the buyer. The second received data can be transformed into a second message. The second message can withhold an identity of the seller thereby making the seller anonymous. The second message can characterize the seller counter-offer and at least three structured buyer replies. The first structured buyer reply can be a new counter-offer, the second structured buyer reply can be the accepting of the seller counter-offer, and the third structured buyer reply can be the rejection of the seller counter-offer. The second message can be transmitted to the buyer to prompt the buyer to select one of the structured buyer replies, thereby advancing the transaction between the seller and the buyer. A notification message can be transmitted to the buyer and to the seller automatically withdrawing the offer to buy in response to the product having sold to a third party thereby stopping the transaction between the seller and the buyer. A notification message can be transmitted to the buyer and to the seller automatically withdrawing the offer to buy in response to an expiration of a pendency of the offer for sale thereby stopping the transaction between the seller and the buyer. Data can be stored characterizing the received data to create a record of the transaction for future review by at least one of the buyer and the seller. An existence of a social network connection between the buyer and the seller can be determined. Data characterizing the existence of the social network connection to the seller can be transmitted.

The plurality of online marketplaces can be monitored for a completion of one of the plurality of posted formatted offers. All of the plurality of posted formatted offers can be removed from each of their respective online marketplace.

Articles of manufacture are also described that comprise computer executable instructions permanently stored (e.g., non-transitorily stored, etc.) on computer readable media, which, when executed by a computer, causes the computer to perform operations herein. Similarly, computer systems are also described that can include a processor and a memory coupled to the processor. The memory can temporarily or permanently store one or more programs that cause the processor to perform one or more of the operations described herein. In addition, methods can be implemented by one or more data processors either within a single computing system or distributed among two or more computing systems.

The subject matter described herein provides many advantages. Sellers can post products for sale quickly, across multiple online marketplaces. The posting can be tiered, to allow for exclusive sales or offer details to groups of buyers. The seller can leverage a combined local and non-local transaction model. The seller can quickly and easily post an offer to multiple groups of potential buyers where the terms of the offer vary between the groups. The seller can post an offer that is restricted to buyers that are connected to the seller through a social network. The buyer can filter search results by offer location and compare a local offer for sale with a non-local offer for sale to find the offer that best suits the buyer. Additionally, communication between seller and buyer is improved.

The details of one or more variations of the subject matter described herein are set forth in the accompanying drawings and the description below. Other features and advantages of the subject matter described herein will be apparent from the description and drawings, and from the claims.

### DESCRIPTION OF DRAWINGS

FIG. 1 is a flow diagram of a process of posting an offer for sale of a good or product to a plurality of groups of potential buyers;

FIG. 2 is a flow diagram of a process of structuring a transaction;

FIG. 3 is a flow diagram showing a process of posting an offer for sale to a plurality of online marketplaces;

FIG. 4 is a system diagram illustrating a device connected via a network to a server;

FIG. 5 is a system diagram illustrating the components of a mobile device;

FIG. 6 is a process flow diagram illustrating the steps of generating and posting an offer for sale to multiple online marketplaces; and

FIG. 7 is a diagram illustrating the modules of the server.

Like reference symbols in the various drawings indicate like elements.

### DETAILED DESCRIPTION

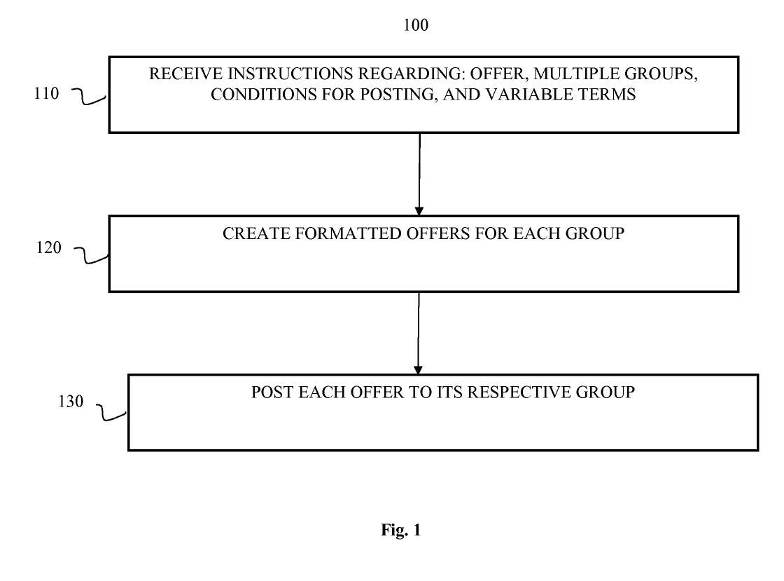

FIG. 1 is a flow diagram of a process 100 of posting an offer for sale of a good or product to a plurality of groups of potential buyers, where the terms of the offer are different between at least two of the groups. The groups are determined based on an affinity relationship a group of potential buyers can have to the seller. For example, the price of the offer can vary between groups based on the affinity relationship. Additionally, offers can be posted to a group once certain conditions are met, such as the length of pendency of another offer.

At step 110, instructions can be received regarding an offer for sale of a product, groups the offer should reach, the conditions that must be met for each group to receive the offer, how the terms of the offer should vary based on an affinity relationship the seller has to the members of each group. The product can be a good or service. The groups can be potential buyers and the group can be determined based on an affinity relationship between the seller and the potential buyers in the group.

At step 120, formatted offers for each group are created from the received instructions. Each formatted offer corresponds to a respective group. The formatted offers include the terms of the offer and the terms can vary between at least two of the formatted offers based on the affinity relationship between the seller and the members of the group.

At step 130, at least two of the formatted offers can be posted to their corresponding groups. The offers can be posted to online marketplaces. The formatted offers can be posted based on conditions. For example, a condition for a first formatted offer to be posted can be that a second formatted offer must be pending for a period of time prior to posting the first formatted offer. This would provide for a period of offer exclusivity to the group corresponding to the second formatted offer.

The affinity relationship can be a social network connection such as, e.g., a “friend” connection on social networking site Facebook. Connections on any other social networking websites such as LinkedIn and MySpace can be used to determine membership in a group. The affinity relationship can be multiple degrees of connections on a social networking site. For example, “friends” of “friends” can comprise a group (such that each member in the group is a “friend” of a “friend” of the seller) and “friends” of an organization can comprise a group. The affinity relationship can be a membership in an association. For example, a group can comprise members of a college alumni club or members of a seller's frequent buyer/rewards club. The seller is not required to be a member of the club. The affinity relationship can be determined based on a geographical proximity to the seller. For example, a group can comprise the potential buyers within a ten mile radius of a location of the seller. The affinity relationship can be use of an online marketplace. For example, a group can comprise users viewing the offer through Ebay.

The terms of the offer can vary based on the affinity relationship between the seller and one of the groups. The terms can include the price of the offer, pendency of the offer and shipping and handling fees. The terms can vary between groups. For example, the offer terms corresponding to a group comprising all potential buyers with a direct social network connection to the seller can include a lower price than the offer terms corresponding to a group comprising potential buyers viewing the offer by using Ebay. As a second example, the offer terms corresponding to a group comprising the potential buyers within a ten mile radius of a location of the seller can include no shipping and handling fees than the offer terms corresponding to a group comprising potential buyers outside of a ten mile radius of the location of the seller.

The online marketplaces can include websites such as Amazon, Ebay, Eggdrop, and Craigslist and can also include social networking sites such as Facebook, LinkedIn and MySpace. Further, the online marketplaces can include communication media that allows the communication of an offer directly to a user such as email, SMS texts, instant messaging, etc.

Using the current subject matter, a seller can, for example, provide for “friends only pricing.” For example, an offer for sale of a product can be offered generally (e.g. on Ebay) at one price while also being offered to a selective or preferential group of friends at a second lower price (e.g. on Facebook). The seller can also, for example, tier the offer for sale among several different online marketplaces. For example, an offer for sale of a product can be posted first on Facebook, then after a predetermined offer pendency, the offer can be automatically posted to LinkedIn and Ebay.

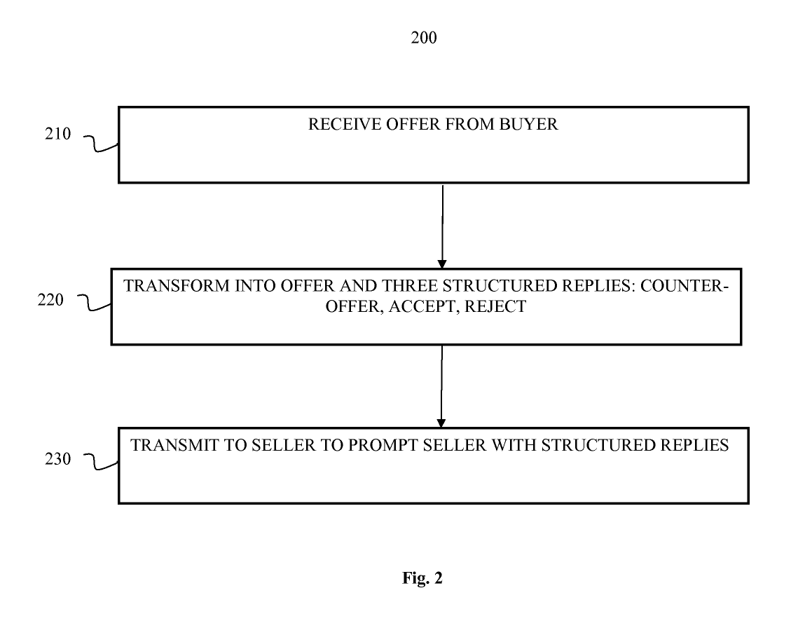

FIG. 2 is a flow diagram 200 of a process of structuring a transaction. The process embeds structured replies in a messaging system thereby providing a guide for both the buyer and the seller during the transaction negotiations. Furthermore, the process provides for anonymous negotiations to protect the identity of both parties to increase security and confidence of performing the transaction.

At step 210, an incoming message characterizing an offer to buy a product is received from a buyer, the incoming message intended for a seller. The incoming message can be, for example, an “instant message.” The buyer offer can include a price the buyer is willing to pay for the product which is different than a price the seller offered to sell the product for.

At step 220, the incoming message is transformed to create a message which includes the buyer offer and also includes a characterization of at least three structured seller responses to the buyer offer. The responses are: counter-offer, accept, and reject. The message also can withhold the identity of the buyer thereby protecting the buyer's identity.

At step 230, the message is transmitted to the seller to prompt the seller to select one the structured replies. By automatically prompting the seller to choose a structured reply, the seller can effectively and efficiently respond to a buyer using the predefined actions. Furthermore, the identity of the buyer is protected, thus providing increased security for the buyer. The process 200 can further include determining an existence of a social network connection between the seller and a buyer. The identity of the buyer can be then included in the message to notify the seller of the buyer's identity and social connection.

The seller can select one of the structured replies after being prompted. If the reply is a counter-offer, data characterizing the structured counter-offer reply is received. The received data is transformed into a second or return message which includes the counter-offer and at least three structured replies, the structured replies being: counter-offer, accept, reject. The second or return message can also withhold the identity of the seller to make the seller anonymous. The second or return message is transmitted to the buyer to prompt the buyer to select one of the structured replies thereby advancing the transaction.

Further, if, for example, the product has sold to a third party (e.g. a second buyer) a notification message can be transmitted to the buyer and the seller automatically withdrawing the offer for sale to stop the transaction. Further, if, for example, the offer for sale of the product included a predetermined offer pendency, a notification message can be transmitted to the buyer and the seller automatically withdrawing the offer to buy or offer to sell to stop the transaction.

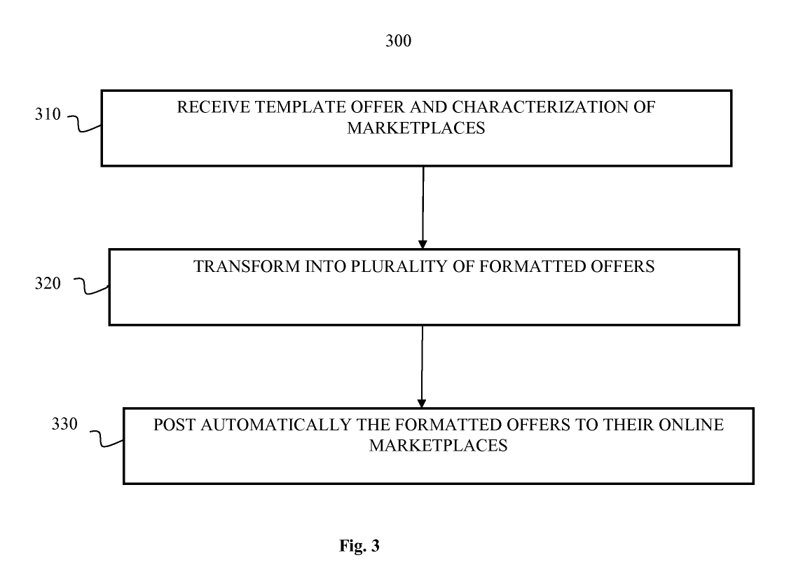

FIG. 3 is a flow diagram 300 illustrating a process of easily and efficiently posting an offer for sale to a plurality of online marketplaces and the management thereof. At step 310, a template offer is received and a characterization of the online marketplaces to which the template offer is to be posted. The template offer is the sale of a good or service and including a price associated with each of the plurality of online marketplaces. The price associated with at least two of the online marketplaces can differ.

At step 320, the received data is transformed into a plurality of formatted offers, each formatted offer corresponding to a respective different online marketplace.

At step 330, the plurality of formatted offers is automatically posted to their respective online marketplaces to offer the product for sale at different prices across a plurality of online marketplaces. The posting of the formatted offers allows a buyer, through one of the online marketplaces, to view and choose to accept one of the posted formatted offers.

The process can further include monitoring the plurality of online marketplaces to which the formatted offers were posted to for a completion of one of the formatted offers. The process can further include removing all of the plurality of posted formatted offers from each of their respective online marketplace.

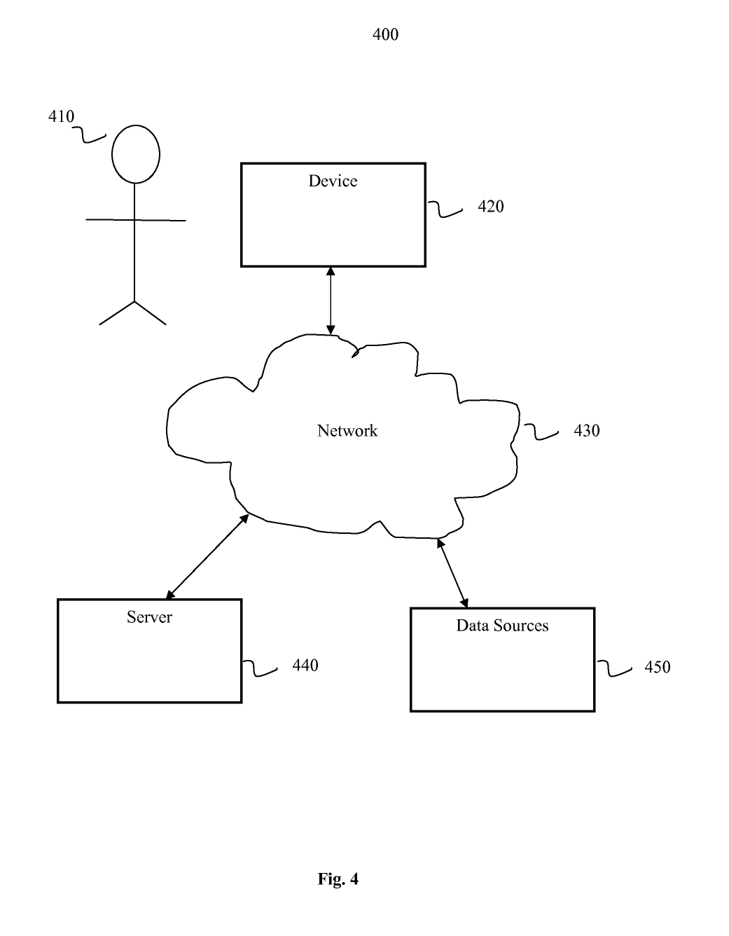

With reference to the system diagram of FIG. 4, a user 410 operating a device 420 communicates via a network 430 to a server 440. The device 420 can be mobile (e.g., smart phones, tablet pc's, IPAD, etc.) or non-mobile (e.g. workstation, personal computer, etc.). The user 410 can act as a seller, i.e. a merchant, or a buyer. Data sources 450 are also connected to network 430. In operation, there are a plurality of user and device pairs, acting as buyers and sellers.

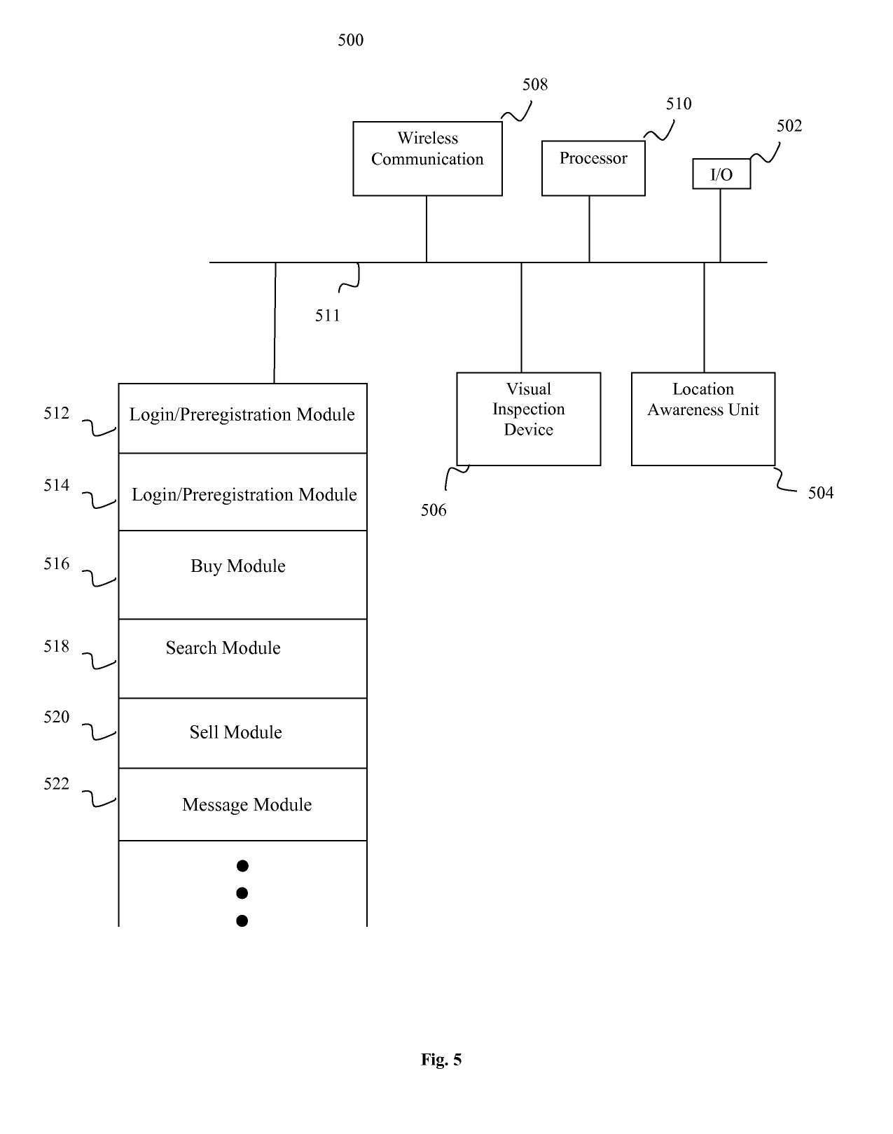

FIG. 5 illustrates the components of a mobile device configured in accordance with an implementation of the subject matter. The device 500 includes standard components, such as an interface 502, location awareness 504, a visual inspection device 506, a wireless communication device 508 and at least one processor 510 all connected by a bus 511.

The interface 502 can include any device to provide for interaction with a user such as a touch screen display, keyboard, pointer, etc. Feedback provided to the user can be any form of sensory feedback, (e.g., visual feedback, auditory feedback, or tactile feedback), and input from the user can be received in any form, including acoustic, speech, or tactile input.

The location awareness 504 can be dedicated hardware, software or a combination of both. The location awareness 504 can be a GPS. Visual inspection device 506 can be any device suitable for forming and capturing visual images. Visual inspection device 506 can be a digital camera.

Wireless communication device 508 is used to connect to the network 130 via any suitable means such as WiFi, cellular data protocol, etc.

A memory 512 is connected to the bus 511. The memory includes executable instructions to support operations associated with an implementation of the present subject matter. The memory 512 includes login/registration module 514, buy module 516, search module 518, sell module 520, and message module 522. The modules together can comprise a mobile application.

The login/registration module 514 includes executable instructions to log the user into the application. Many of the functionalities of the application are available to the user without logging in or registering, however, a user must login/register to finalize a sell or buy transaction. The user is able to enter a username and password which will identify the user. A user is able to retrieve a forgotten password.

The search module 518 includes executable instructions to enable a user to find an offer for sale of an item or product on an online marketplace. The user can also browse through suggested categories. Browsing through multiple subcategories is possible.

The user can make a search by entering the name or keyword of the item he or she is looking for. Relevant offers for sale of the product, such as those with the same or similar names, are returned to the user. The user can view a list of searches the user performed previously. Results from a search are presented as a list of relevant offers with details of the offers. Specifically, offer details can include the transaction type, i.e., if the sale is an auction or fixed price or both. Additionally, filters can be applied to the search results to further refine and narrow the results. Multiple filters can be applied at one time, such as filtering by min/max price, seller location, and seller rating.

The buyer can apply a location filter to the results. Using this filter, relevant offers for sale are organized by the proximity of the buyer to the seller. This provides the buyer an opportunity to find a seller who is geographically close, allowing the buyer to meet the seller in person. The user can view a map of the search results and visualize and discriminate offers based on the distance to the seller. The user's location can be indicated on the map as well as the location of relevant sellers.

Once an offer for sale of a desired product has been found, the user can view the offer, read a detailed description of the product and the seller profile. The user can view pictures of the product. The user can choose to buy the product. The user can also add the offer to a watch list, contact the seller via a messaging center, and schedule a notification for the occurrence of an event. An event can include the product reaching a certain price or certain time left remaining on the offer for sale.

The buyer can also review the seller's user profile. The profile can contain reviews from other users regarding their transaction experience with the seller, items exchanged in the transaction, and when the transaction occurred. The profile can contain the number of transactions the seller has completed in the past, a general message from the seller, and a picture of the seller. The buyer can be able to directly contact a reviewer if they desire further feedback or explanation related to the comment.

The buy module 516 includes executable instructions to purchase a product and manage the transaction. Once a suitable offer for sale has been found using the search module 518, the user can choose to buy the item. When a user chooses to buy an item, the item is placed on their purchase list.

The purchase list manages pending transaction. Each element of the list contains the status of the transaction. The status includes a picture of the product, name of the product, the date it was purchased, if the user has paid for it, if the user has agreed with the seller on a pickup time, if the user has agreed with the seller on a pickup location, and if the transaction is finalized. The purchase list further allows the user to initiate a communication with the seller, see the item description and locate the item on a map.

The sell module 520 includes executable instructions to quickly generate an offer for sale and post the offer to multiple online marketplaces.

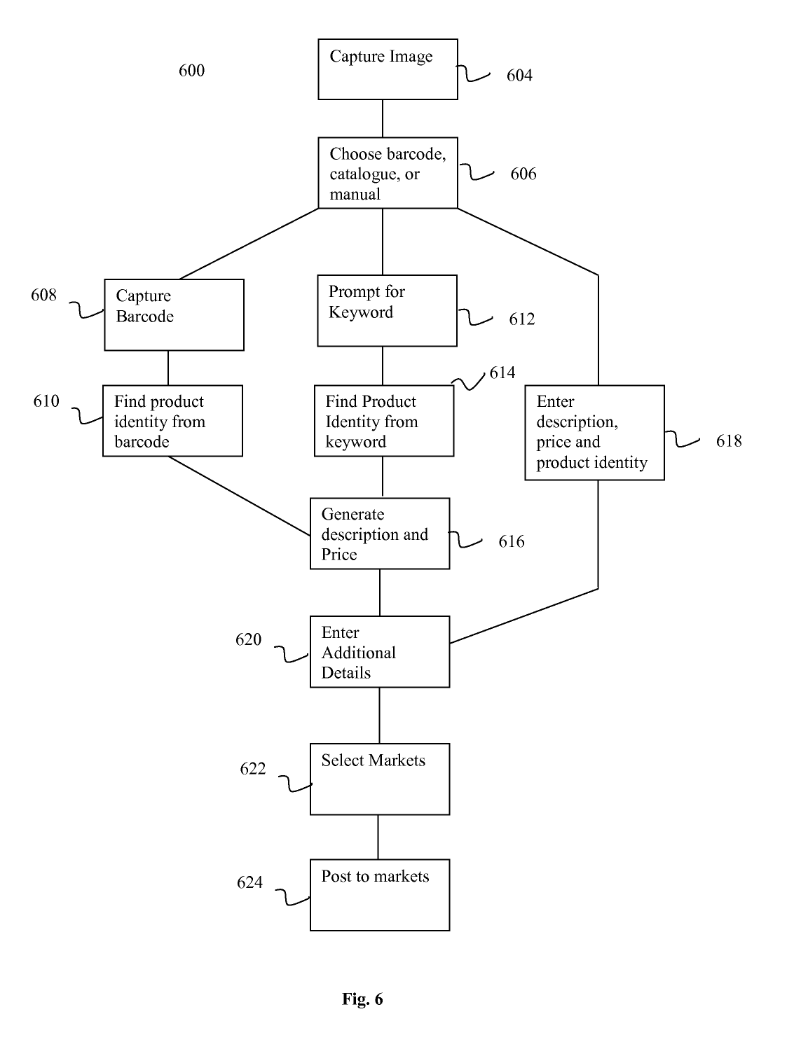

FIG. 6 is a process flow diagram illustrating a method 600, in which, using a mobile device, at 604 the seller captures an image of the product using the visual inspection device 506. The seller can identify the product in multiple ways. At 606, the seller can scan the product barcode, search a catalog by keyword, or enter the identity manually.

At 608, the seller can scan the barcode by focusing the visual inspection device on the product barcode. The barcode is scanned automatically. The product will 610 be identified and the seller can confirm the product identity.

As an alternative to scanning the product barcode, at 612, the seller can enter a keyword describing the identity of the product. At 614, a list of possible identities will be presented for the seller to choose the most appropriate identity.

Once the product identity has been determined, the condition of the item is specified then, at 616, a description and price is automatically generated for the seller.

As an alternative to scanning the product barcode or to entering a keyword, at 618, the seller can manually enter the product identity, description and price.

At 620, the seller can enter additional offer details such as start date and time, duration, location and the types of payments accepted by the seller. The location can be automatically specified from the location of the mobile device. At 622, the seller can specify to which online markets he or she wishes to post the offer.

Returning to FIG. 5, the message module 522 includes executable instruction to enable buyers and sellers to communicate regarding transactions. The conversation format is structured around the product, seller and an interlocutor. The interlocutor is typically a potential buyer, but can also be the server. The communication can be in an instant message format. A buyer can initiate a communication or negotiation with a seller regarding an offer for sale by sending them a message. The buyer can also purchase or place a bid a product through the messaging system. The seller can make a counter offer. The messaging system records the communication so both the buyer and seller has a record of the negotiation.

A conversation is uniquely identified by a sale product and an interlocutor. The message types can include an offer to buy, a counter offer, an offer withdrawal, an offer rejection, accepting an offer, a product withdrawal, a product sale (i.e. the product sold elsewhere) and expiration of offer for sale. Additional message types can be used. The messages can be created by users or by the server.

Once a buyer has purchased a product, if the seller and buyer agree to meet in person to exchange the product for payment, the seller and buyer must organize a time to meet. The seller can suggest one or more different available pickup time-frames by entering his or her availability into a calendar. The buyer can access the calendar and choose a mutually acceptable timeframe.

The modules in memory 512 are exemplary. The functions of individual modules can be combined or divided. It is the functions of the modules that are significant, not the particular implementation or location of any module.

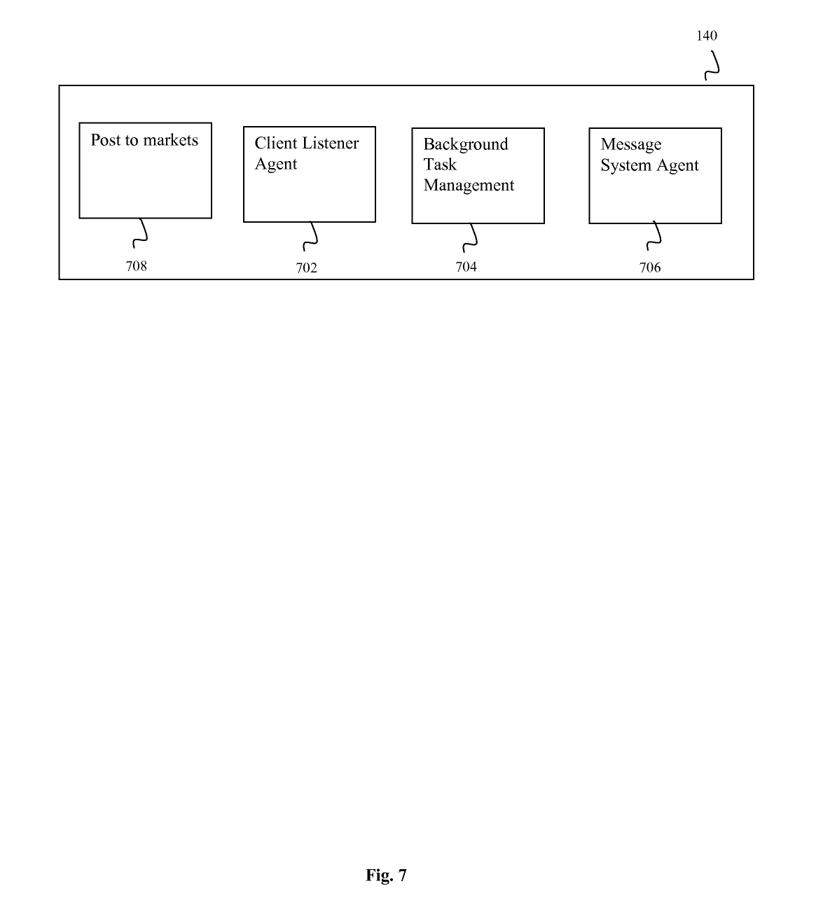

FIG. 7 is a diagram illustrating the modules of server 140. Server 140 works with device 120 to enable the features of the transaction system. The server enables data storage, business processes, enforcing business rules, server-to-user communication, and mediating user-to-user communication. The server is partitioned into agents 702, 704, 706 and 708. Each agent is responsible for a task or set of tasks.

Client listener agent 702 responds to all user-to-server communication and mediates user-to-user communication. Background task agent 704 performs scheduled tasks and carries out policies based on user requests that are beyond the scope of the client listener agent 702. Message system agent 706 handles message storage and access. Analytics agent 708 suggests a price and description for products based on their condition and past sell prices and sell rates.

Other implementations are within the scope and spirit of the subject matter described herein.

Various implementations of the subject matter described herein can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which can be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the term “machine-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the subject matter described herein can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The subject matter described herein can be implemented in a computing system that includes a back-end component (e.g., as a data server), or that includes a middleware component (e.g., an application server), or that includes a front-end component (e.g., a client computer having a graphical user interface or a Web browser through which a user can interact with an implementation of the subject matter described herein), or any combination of such back-end, middleware, or front-end components. The components of the system can be interconnected by any form or medium of digital data communication (e.g., a communication network). Examples of communication networks include a local area network (“LAN”), a wide area network (“WAN”), and the Internet.

The computing system can include clients and servers. A client and server are generally remote from each other and typically interact through a communication network. The relationship of client and server arises by virtue of computer programs running on the respective computers and having a client-server relationship to each other.

Although a few variations have been described in detail above, other modifications are possible. For example, the logic flow depicted in the accompanying figures and described herein do not require the particular order shown, or sequential order, to achieve desirable results. Other embodiments can be within the scope of the following claims.

1. A method for implementation by one or more data processors forming part of at least one computing system comprising:
receiving, by at least one data processor, data characterizing an offer for sale of a good or service by a seller, the seller being an individual, the data specifying constraints of the offer, the constraints identifying a plurality of groups of potential buyers to which the offer is to be conveyed and characterizing conditions specifying how the offer is to be conveyed to each group, at least one of the groups being a selective group and being determined based on an affinity relationship of the potential buyers in that group to the seller, the terms of the offer varying between at least the selective group and the remaining groups based on the affinity relationship between the potential buyers in the respective group and the seller;
wherein the affinity relationship comprises a social network connection between the potential buyers in the respective group and the seller;
generating, with at least one data processor and using the received data, a plurality of formatted offers, each formatted offer corresponding to a respective group and to an online marketplace, the formatted offers characterizing the varying terms of the offer, at least two of the formatted offers having different terms; and
posting, with at least one data processor, two or more of the formatted offers to different respective groups according to the conditions specifying how the offer is to be conveyed to such group, wherein at least one of the two or more offers is posted to a different group only after an exclusive period of offer pendency of another one of the two or more offers.

2. (canceled)

3. The method of claim 1, wherein the social network is selected from a group consisting of: Facebook, MySpace, LinkedIn, and Google+.

4. The method of claim 1, wherein the affinity relationship comprises a connection to a common entity via a social network, the seller also having a connection to the common entity via a social network connection.

5. The method of claim 1, wherein the affinity relationship further comprises a membership in an association.

6. The method of claim 1, wherein the affinity relationship further comprises a geographical proximity to the seller.

7. The method of claim 1, wherein the affinity relationship further comprises use of a specific online marketplace.

8. The method of claim 1, wherein posting to the respective group includes posting the formatted offers to online marketplaces, the online marketplaces being selected from a group consisting of: Facebook, Myspace, LinkedIn, Google Shopping, Ebay, Eggdrop, Peddle, Amazon, and Craigslist.

9. The method of claim 1, wherein the varying terms of the offer include a price.

10. The method of claim 1, wherein the varying terms of the offer include a shipping fee.

11. (canceled)

12. A method for implementation by one or more data processors forming part of at least one computing system comprising:
receiving, by at least one data processor, data characterizing an offer from a buyer to a seller to buy a product, the product being a good or service, the seller being an entity that posted an offer for sale of the product to an online marketplace, the buyer being an entity having viewed the offer for sale;
generating, with at least one data processor and using the received data, a message, the message withholding an identity of the buyer thereby making the buyer anonymous, the message characterizing the offer to buy and at least three structured seller replies, the first structured seller reply being a counter-offer, the second structured seller reply being an accepting of the offer to buy, and the third structured seller reply being a rejection of the offer to buy; and
transmitting, with at least one data processor, the message to the seller to prompt the seller to select one of the structured seller replies, thereby advancing a transaction between the seller and the buyer.

13. The method of claim 12, further comprising:
receiving second data characterizing the selected structured reply, the selected structured reply being the counter-offer from the seller to the buyer;
transforming the second received data into a second message, the second message withholding an identity of the seller thereby making the seller anonymous, the second message characterizing the seller counter-offer and at least three structured buyer replies, the first structured buyer reply being a new counter-offer, the second structured buyer reply being the accepting of the seller counter-offer, and the third structured buyer reply being the rejection of the seller counter-offer; and
transmitting the second message to the buyer to prompt the buyer to select one of the structured buyer replies, thereby advancing the transaction between the seller and the buyer.

14. The method of claim 12, further comprising:
transmitting a notification message to the buyer and to the seller automatically withdrawing the offer to buy in response to the product having sold to a third party thereby stopping the transaction between the seller and the buyer.

15. The method of claim 12, further comprising:
transmitting a notification message to the buyer and to the seller automatically withdrawing the offer to buy in response to an expiration of a pendency of the offer for sale thereby stopping the transaction between the seller and the buyer.

16. The method of claim 12, further comprising:
storing data characterizing the received data to create a record of the transaction for future review by at least one of the buyer and the seller.

17. The method of claim 12, further comprising:
determining an existence of a social network connection between the buyer and the seller; and
transmitting data characterizing the existence of the social network connection to the seller.

18. A method for implementation by one or more data processors forming part of at least one computing system comprising:
receiving, by at least one data processor, data characterizing a single template offer, a plurality of online marketplaces and a location associated with the template offer, the location based on a location of a mobile device, the template offer being the sale of a good or service and including a price associated with each of the plurality of online marketplaces the price associated with at least two of the online marketplaces differ;
transforming with at least one data processor, the received data into a plurality of formatted offers, each formatted offer corresponding to a respective different online marketplace, at least one of the plurality of formatted offers including the location associated with the template offer; and
automatically posting the plurality of formatted offers to their respective online marketplaces with at least one data processor thereby offering the product for sale at different prices concurrently, wherein a buyer, through at least one of the respective different online marketplaces, can view and choose to accept one of the posted formatted offers.

19. The method of claim 18, wherein at least one of the plurality of online market places are selected from a group consisting of: Facebook, Myspace, LinkedIn, Google Shopping, Ebay, Eggdrop, Peddle, Amazon, and Craigslist.

20. The method of claim 18, further comprising:
monitoring the plurality of online marketplaces for a completion of one of the plurality of posted formatted offers.

21. The method of claim 20, further comprising:
removing all of the plurality of posted formatted offers from each of their respective online marketplace.
